(19) United States
(12) Patent Application Publication
(10) Pub. No.: US 2025/0160410 A1
(43) Pub. Date: May 22, 2025

(54) CARTRIDGE FOR AN AEROSOL-GENERATING SYSTEM AND AN AEROSOL GENERATING SYSTEM WITH IMPROVED LIQUID DELIVERY

(71) Applicant: Philip Morris Products S.A., Neuchâtel (CH)

(72) Inventors: Onur DAYIOGLU, Neuchâtel (CH); Ivan EUSEPI, Castel Maggiore (IT); Giovanni MADERA, Bologna (BO) (IT)

(73) Assignee: Philip Morris Products S.A., Neuchâtel (CH)

(21) Appl. No.: 18/835,519

(22) PCT Filed: Feb. 9, 2023
(86) PCT No.: PCT/EP2023/053234

§ 371 Date: Aug. 2, 2024

(30) Foreign Application Priority Data
Feb. 11, 2022 (EP) 22156386.9

(51) Int. Cl. A24F 40/44; A24F 40/10; A24F 40/42; A24F 40/46; A24F 40/465; H05B 3/22

(52) U.S. Cl. CPC A24F 40/44; A24F 40/10; A24F 40/42; A24F 40/46; A24F 40/465; H05B 3/22

(57) ABSTRACT

A cartridge for an aerosol-generating system is provided, the cartridge including: a housing enclosing a reservoir of liquid aerosol-forming substrate; a heating element having a contact surface; a compressible wicking element positioned in contact with the contact surface of the heating element and in communication with the liquid aerosol-forming substrate in the reservoir; and a pressing element, the compressible wicking element being positioned between the pressing element and the heating element, and the pressing element pressing against the compressible wicking element to urge the compressible wicking element into contact with the contact surface of the heating element. An aerosol generating system including the cartridge is also provided.

The present disclosure relates to aerosol-generating systems that generate aerosol by heating a liquid aerosol-forming substrate. The present disclosure also relates to cartridges for such aerosol-generating systems and the assembly of such cartridges.

Aerosol-generating systems that heat liquid to generate an aerosol are well known. These systems typically use a wicking element to deliver the liquid to a heating element. Liquid in the wicking element is vaporised and subsequently the generated vapour cools to form an aerosol. To provide consistent and sufficient generation of aerosol, it is necessary to ensure that there is a consistent and sufficient delivery of liquid to the heating element. Inconsistent liquid delivery to the heating element can result in a poor experience for the user.

One important factor for consistent liquid delivery to the heating element is the contact between the heating element and the wicking element. When the wicking element is intended to be in contact with the heating element across an extended area, delivery of liquid across that area can be inconsistent because of inconsistent contact between the heating element and the wicking element. Another important factor for consistent liquid delivery is consistent capillarity across the wicking material.

It would be desirable to mitigate factors leading to inconsistent or insufficient delivery of liquid aerosol-forming substrate to a heating element through a wicking element.

In one aspect of the disclosure, there is provided a cartridge for an aerosol-generating system. The cartridge may comprise a housing enclosing a reservoir of liquid aerosol-forming substrate, a heating element having a contact surface, and a compressible wicking element positioned in contact with the contact surface of the heating element and in communication with the liquid aerosol-forming substrate in the reservoir. The cartridge may comprise a pressing element, wherein the wicking element is positioned between the pressing element and the heating element. The pressing element may press against the wicking element to urge the wicking element into contact with the contact surface of the heating element.

The provision of pressing element may provide for a consistent contact area between heating element and wicking element from one cartridge to another. Any variation in the dimensions or orientation of the wicking element or heating element due to manufacturing tolerances may be at least partially mitigated by the provision of the pressing element. This may result in a more consistent liquid delivery across the heating element and so more consistent generated aerosol. It will also avoid dry conditions at the heating element that might lead to overheating and the formation of undesirable aerosol constituents.

The wicking element may be positioned in constant contact with the contact surface of the heating element.

The wicking element may have a front face in contact with the contact surface of the heating element and a rear face in contact with the pressing element. The rear face may have a periphery and a central area inward of the periphery. The pressing element may contact the rear face in a central area spaced inwardly from a periphery of the rear face.

The periphery of the rear face surrounds the central area of the rear face. For example, in embodiments in which the rear face has a circular shape, the periphery may be an outer annular area that surrounds a circular central area. In embodiments in which the rear face is rectangular, the central area may be a central rectangle and the periphery may be an outer frame around the central area. The central area may have the same aspect ratio as the rear face.

A diameter or width of the rear face along an axis may have a length D. The extent of central area along the axis may have a length C, and the extent of the periphery along that axis may have a length P on either side of the central area, such that D=C+2P. The value of P may be between 0.05 D and 0.4 D, or may be between 0.1 D and 0.2 D, when measured along any axis in the plane of the rear face.

Pressing the wicking element in a central area may have the advantage of improving the uniformity of the capillarity of the wicking element. In some embodiments, a periphery of the wicking element may be more compressed than the central area during a manufacturing process of the wicking element. This may be an unavoidable consequence of the manufacturing process, for example a punching process. Advantageously, the pressing element is provided so that the wicking element is compressed to a greater extent in the central area than at the periphery of the rear face. Advantageously, the periphery of the rear face of the wicking element may be not compressed within the cartridge. This may improve the uniformity of the liquid delivery through the wicking element.

In some embodiments, the wicking element has greater thickness in the central area than at the periphery. Thickness in this context is a dimension in a direction of liquid travel from the rear face to the front face of the wicking element. A front face of the wicking element may be domed to provide a greater thickness in the central area than at the periphery. In these embodiments, the pressing element may be provided so that the wicking element is compressed to a greater extent in the central area than at the periphery of the rear face. This may improve the uniformity of liquid delivery to the front face of the wicking element.

In an uncompressed state, the wicking element may have a greater porosity in the central area than at the periphery. In a compressed state, when the central area is compressed to a greater extent than the periphery, the porosity in the central area can be made substantially equal to the porosity of the periphery, thereby providing a substantially uniform rate of liquid delivery across the front face of the wicking element.

The wicking element may have a circular cross section in a plane parallel to the contact surface. A circular cross section may advantageously reduce the requirements for orienting the wicking element correctly. The wicking element may have a rectangular cross section in a plane parallel to the contact surface. The wicking element may have a regular polygonal cross section in a plane parallel to the contact surface. The wicking element may have an elliptical cross section in a plane parallel to the contact surface. The wicking element may be disc shaped.

The wicking element may comprise a fibrous or spongy material. The wicking element may comprise a bundle of capillaries. For example, the wicking element may comprise one or more of fibres, threads, and fine bore tubes. The wicking element may comprise sponge-like or foam-like material. The structure of the wicking element may form a plurality of small bores or tubes, through which the liquid can be transported by capillary action. The wicking element may comprise an open pore structure. The wicking element may comprise any suitable material or combination of materials. The wicking element may comprise pressed cotton. Other suitable materials include but are not limited to: a fibrous material, for example made of spun or extruded fibres, such as cellulose acetate, polyester, or bonded polyolefin, polyethylene, terylene or polypropylene fibres, or nylon fibres. The wicking element may comprise a plurality of layers of different material.

In one embodiment the wicking element is formed from cotton fibres. The cotton fibres are physically bound to each other in a continuous flow manufacturing process. Using a mechanical puncher the wicking material is given the required shape for the wicking element.

The liquid aerosol-forming substrate is preferably absorbed in the wicking element. The element may be configured to store, or may store, at least 0.02, 0.05, 0.1, 0.2, or 0.5 ml of liquid aerosol-forming substrate. The wicking element may be configured to store, or may store, equal to or less than 2 ml or 5 ml of liquid aerosol-forming substrate.

The liquid aerosol-forming substrate from the reservoir may pass the pressing element to reach the wicking element. The liquid aerosol-forming substrate from the reservoir may pass the pressing element to reach the wicking element in the direction in which the pressing element presses against the wicking element.

The pressing element may be configured to allow liquid to pass through the pressing element in a direction normal to the rear face of the wicking element.

The pressing element may be liquid permeable. Liquid permeable in this context means that liquid may permeate through pores or openings in the pressing element. The pressing element may comprise a mesh, net or lattice structure.

The pressing element may comprise a hollow pressing member that liquid aerosol-forming substrate from the reservoir can pass through to reach the wicking material. The pressing element may comprise one or more pins, tabs or tubes. The pressing element may provide plural, separate points of contact with the wicking element. The pressing element may comprise a continuous, closed loop of contact with the wicking element.

The pressing element may be stiffer than the wicking element so as to provide a compressive force on the wicking element. The heating element may also be stiffer than the wicking element.

The pressing element, or a portion of the pressing element, may be integral with the housing. The pressing element, or a portion of the pressing element, may be separate to the housing. The pressing element may be positioned between the housing and the wicking element. The pressing element may be fixed relative to the heating element.

The pressing element may comprise a convex surface in contact with a rear face of the wicking element. The convex shape of the pressing element may match a dome shaped front face of the wicking element. The pressing element may have a pressing surface with a smaller area than the rear surface of wicking element. In particular the pressing surface may not contact a periphery of the rear surface of the wicking element. This means that a periphery of the wicking element is not compressed by the pressing element. Advantageously, the pressing element may provide for substantially uniform porosity in the wicking element when the wicking element is pressed by the pressing element.

The heating element may be fluid permeable. The heating element may comprise a mesh. The heating element may be a mesh heating element. The heating element may be a perforated heating element. A mesh or perforated heating element may provide an extended heating surface area. This extended heating surface area may provide efficient vaporisation of aerosol-forming substrate.

The heating element may be fixed to the housing. The heating element may comprise electrical contacts for connection with an external power supply. The heating element may be configured to be resistively heated. The heating element may be configured to be inductively heated. The heating element may comprise a susceptor configured to be inductively heated. The heating element may be configured to vapourise the liquid aerosol-forming substrate.

The heating element may be planar. The heating element may take the form of a sheet. The heating element may have a thickness that is an order of magnitude or more smaller than a width, length or diameter of the heating element.

The area of the heating element (normal to its thickness) may be, for example less than or equal to 50 square millimetres, preferably less than or equal to 25 square millimetres, more preferably approximately 15 square millimetres. The size is chosen such to incorporate the heating element into a handheld system. Sizing of the heating element to be less or equal than 50 square millimetres reduces the amount of total power required to heat the heating element while still ensuring a sufficient contact area between the heating element and the wicking element. The heating element may, for example, be rectangular and have a length between 2 millimetres to 10 millimetres and a width between 2 millimetres and 10 millimetres.

The heating element, or portions thereof, may comprise or be formed from any material with suitable electrical and mechanical properties, for example a suitable, electrically resistive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, Constantan, nickel-, cobalt-, chromium-, aluminium-, titanium-, zirconium-, hafnium-, niobium-, molybdenum-, tantalum-, tungsten-, tin-, gallium-, manganese-and iron-containing alloys, and super-alloys based on nickel, iron, cobalt, stainless steel, iron-aluminium based alloys and iron-manganese-aluminium based alloys.

As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein with reference to the present invention, an aerosol-forming substrate is a substrate capable of releasing volatile compounds that can form an aerosol. Volatile compounds may be released by heating or combusting the aerosol-forming substrate. Volatile compounds may be released by moving the aerosol-forming substrate through passages of a vibratable element. The aerosol forming substrate may comprise both liquid and solid components.

The aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

The aerosol-forming substrate may comprise nicotine. The nicotine containing aerosol-forming substrate may be a nicotine salt matrix. The liquid aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may comprise homogenised tobacco material. The aerosol-forming substrate may comprise a non-tobacco-containing material. The aerosol-forming substrate may comprise homogenised plant-based material. The aerosol-forming substrate may comprise other additives and ingredients, such as flavourants.

As used herein, the term “liquid aerosol-forming substrate” is used to refer to an aerosol-forming substrate in condensed form. Thus, the “liquid aerosol-forming substrate” may be, or may comprise, one or more of a liquid, gel, or paste. If the liquid aerosol-forming substrate is, or comprises, a gel or paste, the gel or paste may liquidise upon heating. For example, the gel or paste may liquidise upon heating to a temperature of less than 50, 75, 100, 150, or 200 degrees Celsius.

The cartridge may further comprise an air inlet, an air outlet and an airflow path from the air inlet to the air outlet. The airflow path may pass the heating element. The heating element may have a second surface opposite the contact surface. The second surface may be within the airflow path. The cartridge may further comprise a mouthpiece configured to allow a user to apply a negative pressure to the mouthpiece and draw air through the airflow path.

The cartridge may be configured to connect to a reusable device. The device may comprise a power supply and control electronics. When the aerosol-forming substrate is exhausted, the cartridge can be replaced and new cartridge can be used with the reusable device.

In another aspect of the disclosure, there is provided an aerosol generating system.

It is possible to provide an aerosol generating system as a single piece system. The aerosol generating system may comprise:
a housing enclosing a reservoir of liquid aerosol-forming substrate;
a heating element fixed to the housing;
a compressible wicking element positioned in contact with a surface of the heating element and in communication with the liquid in the reservoir; and
a pressing element, wherein the wicking element is positioned between the pressing element and the heating element, and wherein the pressing element presses against the wicking element to urge the wicking material into contact with the surface of the heating element.

Features of the wicking element, the pressing element, the heating element and the aerosol-forming substrate described in relation to the first aspect of the disclosure also apply to this aspect of the disclosure.

The aerosol-generating system may further comprise an air inlet, an air outlet and an airflow path from the air inlet to the air outlet.

The heating element may be configured to be activated by airflow through the airflow path. The aerosol-generating system may further comprise an airflow sensor. The airflow sensor may be configured to detect air flow through the airflow path. The airflow sensor may be configured to activate the heating element. The aerosol-generating system may further comprise a mouthpiece configured to allow a user to apply a negative pressure to the mouthpiece and draw air through the airflow path.

The aerosol-generating system may further comprise a power supply. The power supply may be a battery. The power supply may be configured to supply power to the heating element. The aerosol-generating system may comprise control electronics. The power supply may be configured to supply power to the heating element via the control electronics.

The aerosol generating system may comprise the cartridge of one aspect of the invention. The aerosol generating system may comprise a reusable device. The cartridge may be configured to engage with the reusable device. The cartridge may be configured to disengage from the reusable device. The reusable device may be configured to engage with, and disengage from, the cartridge via a snap-fit connection, corresponding screw threads or any other suitable means. The reusable device may comprise a chamber configured to receive at least a portion of the cartridge.

The reusable device may comprise an air inlet. The reusable device may comprise an air outlet. When the reusable device is engaged with the cartridge, the air outlet of the reusable device may be in fluid communication with the air inlet of the cartridge.

The reusable device may comprise a power supply. The power supply may be a battery. The power supply may be configured to supply power to the heating element. The power supply may be configured to supply power to the heating element only when the cartridge is engaged with the reusable device. The power supply may be electrically connected to device electrical contacts of the reusable device. These device electrical contacts may be configured to form an electrical connection with corresponding electrical contacts on the cartridge when the cartridge is engaged with the reusable device. The reusable device may comprise control electronics. The power supply may be configured to supply power to the heating element via the control electronics.

In a still further aspect of the disclosure, there is provided a method of assembling a cartridge for an aerosol generating system, comprising:
providing a housing for enclosing a reservoir of liquid aerosol-forming substrate;
providing a heating element having a contact surface;
providing a compressible wicking element; and
pressing the wicking element against the contact surface using a pressing element, wherein the wicking element is positioned between the pressing element and the heating element, and
providing a liquid aerosol-forming substrate in the housing, the liquid aerosol-forming substrate in the housing being in fluid communication with the wicking element.

Features of the wicking element, the pressing element, the heating element and the aerosol-forming substrate described in relation to the first aspect of the disclosure also apply to this aspect of the disclosure.

In a yet further aspect of the disclosure, there is provided a method of generating an aerosol, comprising:
providing a heating element,
providing a wicking element in contact with the heating element, the wicking element comprising a liquid aerosol-forming substrate,
pressing the wicking element against the heating element,
heating the heating element to vapourise the liquid, aerosol-forming substrate, and cooling the vapour in an airflow to form an aerosol.

Features of the wicking element, the pressing element, the heating element and the aerosol-forming substrate described in relation to the first aspect of the disclosure also apply to this aspect of the disclosure.

Below there is provided a non-exhaustive list of non-limiting examples. Any one or more of the features of these examples may be combined with any one or more features of another example, embodiment, or aspect described herein.

EX1. A cartridge for an aerosol-generating system, the cartridge comprising:
a housing enclosing a reservoir of liquid aerosol-forming substrate;
a heating element having a contact surface;
a compressible wicking element positioned in contact with the contact surface of the heating element and in communication with the liquid aerosol-forming substrate in the reservoir; and
a pressing element, wherein the wicking element is positioned between the pressing element and the heating element, and wherein the pressing element presses against the wicking element to urge the wicking element into contact with the contact surface of the heating element.

EX2. A cartridge according to example EX1, wherein the wicking element has a front face in contact with the contact surface of the heating element and a rear face in contact with the pressing element, and wherein the pressing element contacts the rear face in a central area spaced inwardly from a periphery of the rear face.

EX 3. A cartridge according to example EX1 or EX2, wherein the wicking element is not pressed at the periphery of the rear face.

EX4. A cartridge according to example EX2, wherein the pressing element is provided so that the wicking element is compressed to a greater extent in the central area than at the periphery of the rear face.

EX5. A cartridge according to any one of examples EX2 to EX4, wherein the wicking element has greater thickness in the central area than at the periphery.

EX6. A cartridge according to any one of examples EX2 to EX5, wherein, in an uncompressed state, the wicking element has a greater porosity in the central area than at the periphery.

EX7. A cartridge according to any one of examples EX1 to EX6, wherein a front face of the wicking element is domed.

EX8. A cartridge according to any one of examples EX1 to EX7, wherein the wicking element has a circular cross section in a plane parallel to the contact surface.

EX9. A cartridge according to any one of examples EX1 to EX8, wherein the wicking element comprises a fibrous or spongy material.

EX10. A cartridge according to any one of examples EX1 to EX9, wherein the wicking element comprises pressed cotton.

EX11. A cartridge according to any one of examples EX1 to EX10, wherein the wicking element comprises a plurality of layers of different material.

EX12. A cartridge according to any one of the examples EX1 to EX11, wherein the pressing element is liquid permeable.

EX13. A cartridge according to any one of the examples EX1 to EX12, wherein the pressing element comprises a hollow pressing member that liquid aerosol-forming substrate from the reservoir can pass through to reach the wicking material.

EX14. A cartridge according to any one of the examples EX1 to EX13, wherein the pressing element is integral with the housing.

EX15. A cartridge according to any one of the examples EX1 to EX13, wherein the pressing element is positioned between the housing and the wicking element.

EX 16. A cartridge according to any one of the examples EX1 to EX15, wherein the pressing element is stiffer than the wicking element.

EX17. A cartridge according to any one of the examples EX1 to EX16, wherein the pressing element comprises one or more pins, tabs or tubes.

EX18. A cartridge according to any one of the examples EX1 to EX17, wherein the pressing element comprises a mesh, net or lattice structure.

EX19. A cartridge according to any one of the examples EX1 to EX18, wherein the heating element is fluid permeable.

EX20. A cartridge according to any one of the examples EX1 to EX19, wherein the heating element is planar.

EX21. A cartridge according to any one of the examples EX1 to EX20, wherein the heating element comprises a mesh.

EX22. A cartridge according to any one of the examples EX1 to EX21, wherein the heating element is fixed to the housing.

EX23. A cartridge according to any one of the examples EX1 to EX22, wherein the pressing element provides for uniform porosity in the wicking element when the wicking element is pressed.

EX24. A cartridge according to any one of the examples EX1 to EX23, wherein the heating element comprises electrical contacts for connection with an external power supply.

EX25. A cartridge according to any one of the examples EX1 to EX24, wherein the heating element comprises a susceptor configured to be inductively heated to vapourise the liquid aerosol-forming substrate.

EX26. A cartridge according to any one of the examples EX1 to EX25, wherein the pressing element comprises a convex surface in contact with a rear face of the wicking element.

EX27. A cartridge according to example EX26, wherein the convex surface of pressing element matches a dome shape of the front face of the wicking element.

EX28. A cartridge according to any one of the examples EX1 to EX27, wherein the pressing element has a pressing surface with a smaller a diameter or width than the rear surface of the wicking element.

EX29. A cartridge according to any one of the examples EX1 to EX28, wherein the wicking element is disc shaped.

EX30. A cartridge according to any one of the examples EX1 to EX29, wherein the wicking element comprises an annular hub and a plurality of protrusions connected to the hub.

EX31. A cartridge according to any one of the examples EX1 to EX30, wherein the liquid aerosol-forming substrate from the reservoir can pass the pressing element in the direction in which the pressing element presses against the wicking element.

EX32. A cartridge according to any one of the examples EX1 to EX31, wherein the pressing element is configured to allow liquid to pass through the pressing element in a direction normal to the rear face of the wicking element.

EX33. An aerosol generating system comprising:
a housing enclosing a reservoir of liquid aerosol-forming substrate;
   a heating element fixed to the housing;
   a compressible wicking material positioned in contact with a surface of the heating element and in communication with the liquid in the reservoir; and
   a pressing element, wherein the wicking material is positioned between the pressing element and the heating element, and wherein the pressing element presses against the wicking material to urge the wicking material into contact with the surface of the heating element.

EX34. An aerosol generating system according to example EX33, wherein the wicking element has a front face in contact with the contact surface of the heating element and a rear face in contact with the pressing element, and wherein the pressing element contacts the rear face in a central area spaced inwardly from a periphery of the rear face.

EX 35. An aerosol generating system according to example EX33 or EX34, wherein the wicking element is not pressed at the periphery of the rear face.

EX36. An aerosol generating system according to example EX35, wherein the pressing element is provided so that the wicking element is compressed to a greater extent in the central area than at the periphery of the rear face.

EX37. An aerosol generating system according to any one of examples EX34 to EX36, wherein the wicking element has greater thickness in the central area than at the periphery.

EX38. An aerosol generating system according to any one of examples EX34 to EX37, wherein, in an uncompressed state, the wicking element has a greater porosity in the central area than at the periphery.

EX39. An aerosol generating system according to any one of examples EX33 to EX38, wherein a front face of the wicking element is domed.

EX40. An aerosol generating system according to any one of examples EX33 to EX39, wherein the wicking element has a circular cross section in a plane parallel to the contact surface.

EX41. An aerosol generating system according to any one of examples EX33 to EX40, wherein the wicking element comprises a fibrous or spongy material.

EX42. An aerosol generating system according to any one of examples EX33 to EX41, wherein the wicking element comprises pressed cotton.

EX43. An aerosol generating system according to any one of examples EX33 to EX42, wherein the wicking element comprises a plurality of layers of different material.

EX44. An aerosol generating system according to any one of the examples EX33 to EX43, wherein the pressing element is liquid permeable.

EX45. An aerosol generating system according to any one of the examples EX33 to EX44, wherein the pressing element comprises a hollow pressing member that liquid aerosol-forming substrate from the reservoir can pass through to reach the wicking material.

EX46. An aerosol generating system according to any one of the examples EX33 to EX45, wherein the pressing element is integral with the housing.

EX47. An aerosol generating system according to any one of the examples EX33 to EX45, wherein the pressing element is positioned between the housing and the wicking element.

EX 48. An aerosol generating system according to any one of the examples EX33 to EX47, wherein the pressing element is stiffer than the wicking element.

EX49. An aerosol generating system according to any one of the examples EX33 to EX48, wherein the pressing element comprises one or more pins, tabs or tubes.

EX50. An aerosol generating system according to any one of the examples EX33 to EX49, wherein the pressing element comprises a mesh, net or lattice structure.

EX51. An aerosol generating system according to any one of the examples EX33 to EX50, wherein the heating element is fluid permeable.

EX52. An aerosol generating system according to any one of the examples EX33 to EX51, wherein the heating element is planar.

EX53. An aerosol generating system according to any one of the examples EX33 to EX52, wherein the heating element comprises a mesh.

EX54. An aerosol generating system according to any one of the examples EX33 to EX53, wherein the heating element is fixed to the housing.

EX55. An aerosol generating system according to any one of the examples EX33 to EX54, wherein the pressing element provides for uniform porosity in the wicking element when the wicking element is pressed.

EX56. An aerosol generating system according to any one of the examples EX33 to EX55, wherein the heating element comprises a susceptor configured to be inductively heated to vapourise the liquid aerosol-forming substrate.

EX57. An aerosol generating system according to any one of the examples EX33 to EX56, wherein the pressing element comprises a convex surface in contact with a rear face of the wicking element.

EX58. An aerosol generating system according to example EX57, wherein the convex surface of pressing element matches a dome shape of the front face of the wicking element.

EX59. An aerosol generating system according to any one of the examples EX33 to EX58, wherein the pressing element has a pressing surface with a smaller diameter or width than the rear surface of the wicking element.

EX60. An aerosol generating system according to any one of the examples EX33 to EX59, wherein the wicking element is disc shaped.

EX61. An aerosol generating system according to any one of the examples EX33 to EX60, wherein the wicking element comprises an annular hub and a plurality of protrusions connected to the hub.

EX62. An aerosol generating system according to any one of the examples EX33 to EX61, wherein the liquid aerosol-forming substrate from the reservoir can pass the pressing element in the direction in which the pressing element presses against the wicking element.

EX63. An aerosol generating system according to any one of the examples EX33 to EX62, wherein the pressing element is configured to allow liquid to pass through the pressing element in a direction normal to the rear face of the wicking element.

EX64. An aerosol generating system according to any one of the examples EX33 to EX63, comprising a power supply for providing power to the heating element.

EX65. An aerosol generating system according to any one of the examples EX33 to EX64, comprising control circuitry for controlling the supply of power to the heating element.

EX66.A method of assembling a cartridge for an aerosol generating system, comprising:
providing a housing for enclosing a reservoir of liquid aerosol-forming substrate;
providing a heating element having a contact surface;
providing a compressible wicking element; and
pressing the wicking element against the contact surface using a pressing element,
wherein the wicking element is positioned between the pressing element and the heating element, and
providing a liquid aerosol-forming substrate in the housing, the liquid aerosol-forming substrate in the housing being in fluid communication with the wicking element.

EX67. A method according to example EX66, wherein the wicking element has a front face pressed into contact with the contact surface of the heating element and a rear face in contact with the pressing element, and wherein the pressing element contacts the rear face in a central area spaced inwardly from a periphery of the rear face.

EX 68. A method according to example EX66 or EX67, wherein the wicking element is not pressed at the periphery of the rear face.

EX69. A method according to example EX67, wherein the pressing element is provided so that the wicking element is compressed to a greater extent in the central area than at the periphery of the rear face.

EX70. A method according to any one of examples EX67 to EX69, wherein the wicking element has greater thickness in the central area than at the periphery.

EX71. A method according to any one of examples EX67 to EX70, wherein, in an uncompressed state, the wicking element has a greater porosity in the central area than at the periphery.

EX72. A method according to any one of examples EX66 to EX71, wherein a front face of the wicking element is domed. EX73. A method according to any one of examples EX66 to EX72, wherein the wicking element has a circular cross section in a plane parallel to the contact surface.

EX74. A method according to any one of examples EX66 to EX73, wherein the wicking element comprises a fibrous or spongy material.

EX75. A method according to any one of examples EX66 to EX74, wherein the wicking element comprises pressed cotton.

EX76. A method according to any one of examples EX66 to EX75, wherein the wicking element comprises a plurality of layers of different material.

EX77. A method according to any one of the examples EX66 to EX76, wherein the pressing element is liquid permeable.

EX78. A method according to any one of the examples EX66 to EX77, wherein the pressing element comprises a hollow pressing member that liquid aerosol-forming substrate from the reservoir can pass through to reach the wicking material.

EX79. A method according to any one of the examples EX66 to EX78, wherein the pressing element is integral with the housing.

EX80. A method according to any one of the examples EX66 to EX79, wherein the pressing element is positioned between the housing and the wicking element.

EX 81. A method according to any one of the examples EX66 to EX80, wherein the pressing element is stiffer than the wicking element.

EX82. A method according to any one of the examples EX66 to EX81, wherein the pressing element comprises one or more pins, tabs or tubes.

EX83. A method according to any one of the examples EX66 to EX82, wherein the pressing element comprises a mesh, net or lattice structure.

EX84. A method according to any one of the examples EX66 to EX83, wherein the heating element is fluid permeable.

EX85. A method according to any one of the examples EX66 to EX84, wherein the heating element is planar.

EX86. A method according to any one of the examples EX66 to EX85, wherein the heating element comprises a mesh.

EX87. A method according to any one of the examples EX66 to EX86, wherein the heating element is fixed to the housing.

EX88. A method according to any one of the examples EX66 to EX87, wherein the pressing element provides for uniform porosity in the wicking element when the wicking element is pressed.

EX89. A method according to any one of the examples EX66 to EX88, wherein the heating element comprises electrical contacts for connection with an external power supply.

EX90. A method according to any one of the examples EX66 to EX89, wherein the heating element comprises a susceptor configured to be inductively heated to vapourise the liquid aerosol-forming substrate.

EX91. A method according to any one of the examples EX66 to EX90, wherein the pressing element comprises a convex surface in contact with a rear face of the wicking element.

EX92. A method according to example EX91, wherein the convex surface of pressing element matches a dome shape of the front face of the wicking element.

EX93. A method according to any one of the examples EX66 to EX92, wherein the pressing element has a pressing surface with a smaller diameter or width than the rear surface of the wicking element.

EX94. A method according to any one of the examples EX66 to EX93, wherein the wicking element is disc shaped.

EX95. A method according to any one of the examples EX66 to EX94, wherein the wicking element comprises an annular hub and a plurality of protrusions connected to the hub.

EX96. A method according to any one of the examples EX66 to EX95, wherein the liquid aerosol-forming substrate from the reservoir can pass the pressing element in the direction in which the pressing element presses against the wicking element.

EX97. A method according to any one of the examples EX66 to EX96, wherein the pressing element is configured to allow liquid to pass through the pressing element in a direction normal to the rear face of the wicking element.

EX98. A method of generating an aerosol, comprising:
providing a heating element,
providing a wicking element in contact with the heating element, the wicking element comprising a liquid aerosol-forming substrate,
pressing the wicking element against the heating element,
heating the heating element to vapourise the liquid, aerosol-forming substrate, and
cooling the vapour in an airflow to form an aerosol.

Examples will now be further described with reference to the figures in which:

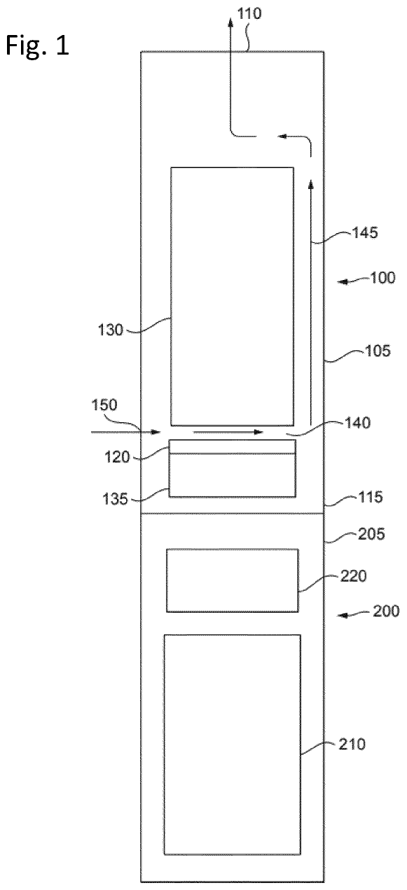

FIG. 1 shows a schematic illustration of an aerosol-generating system according to a first embodiment of the present disclosure;

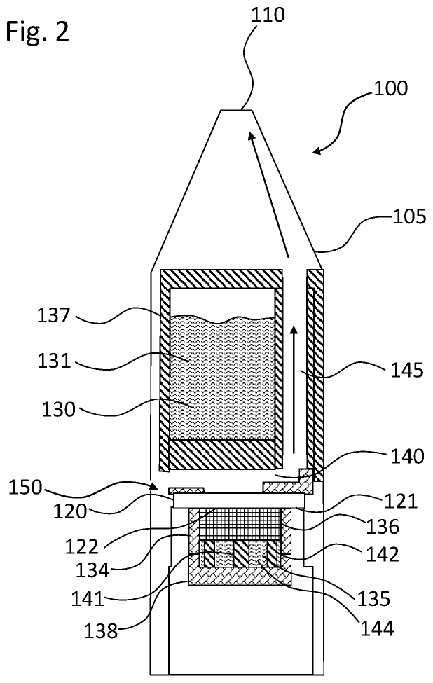

FIG. 2 is a schematic cross section of a cartridge in an aerosol-generating system of the type shown in FIG. 1;

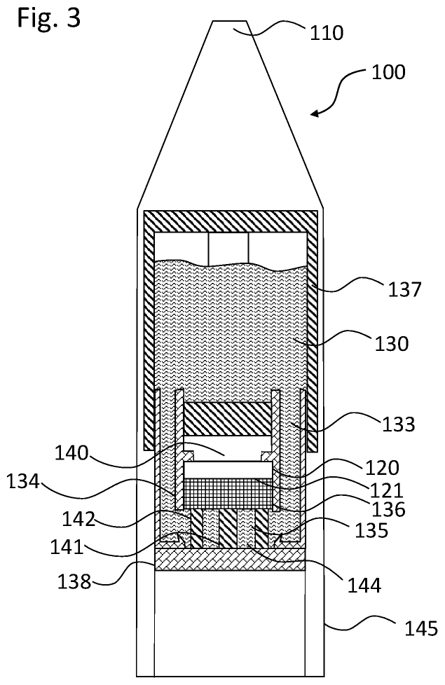

FIG. 3 is a second schematic cross section of the cartridge of FIG. 2;

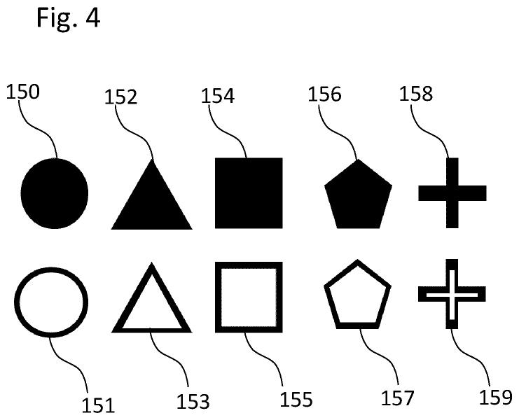

FIG. 4 illustrates possible cross sectional shapes of a pressing element;

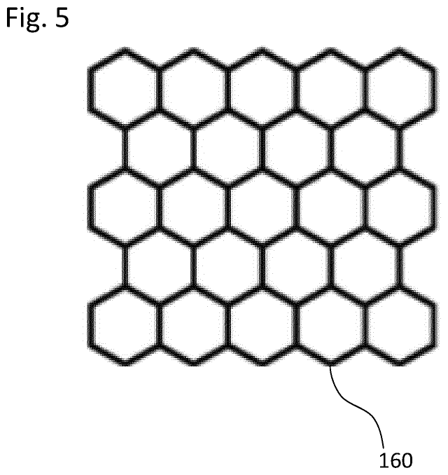

FIG. 5 illustrates another possible form of pressing element;

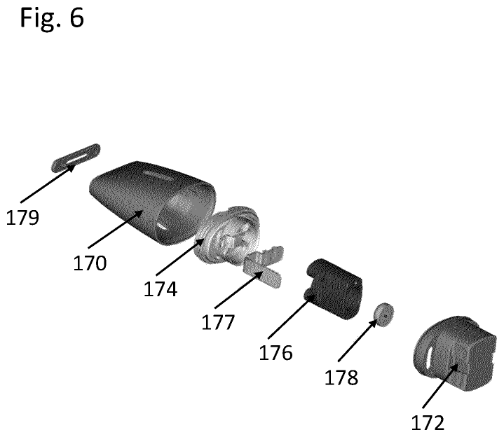

FIG. 6 is an exploded view of a cartridge of the type shown in FIG. 2;

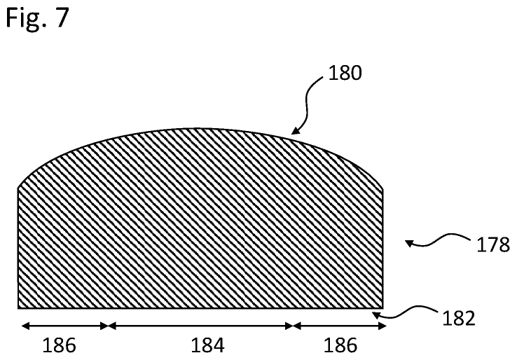

FIG. 7 is a cross section of a wicking element for use the cartridge of FIG. 6;

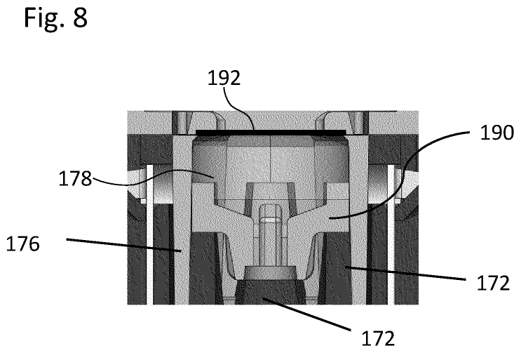

FIG. 8 shows a cross section of a portion of the cartridge of FIG. 7 with a pressing element;

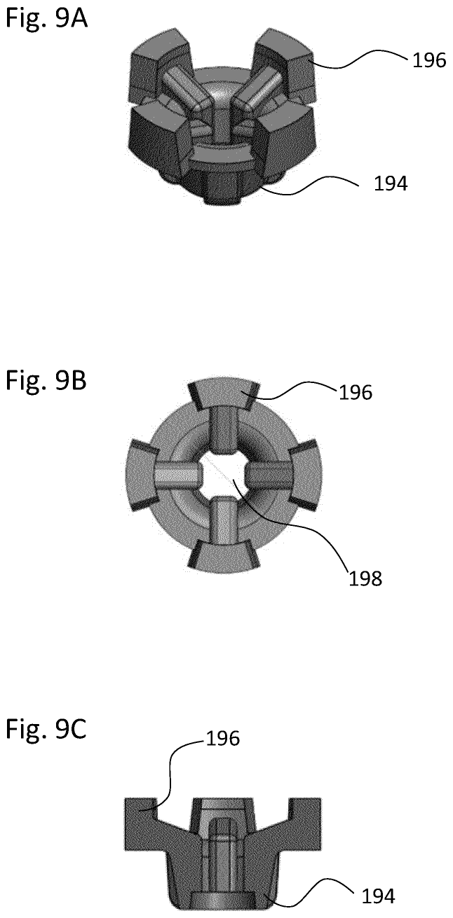

FIGS. 9a, 9b and 9c show the pressing element of FIG. 8;

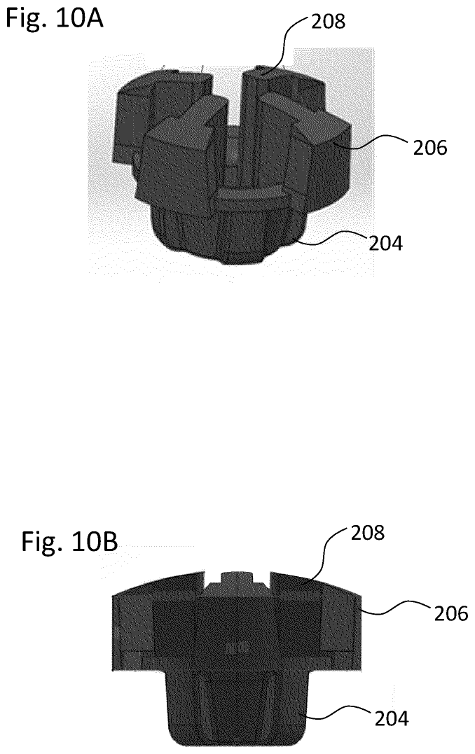

FIGS. 10a and 10b show another pressing element;

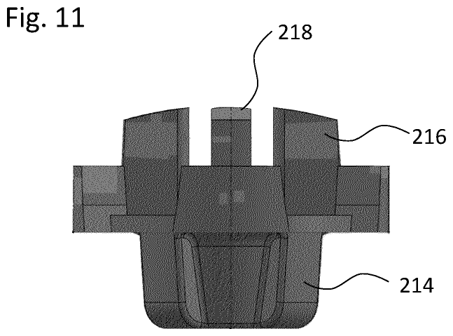

FIG. 11 shows a further pressing element;

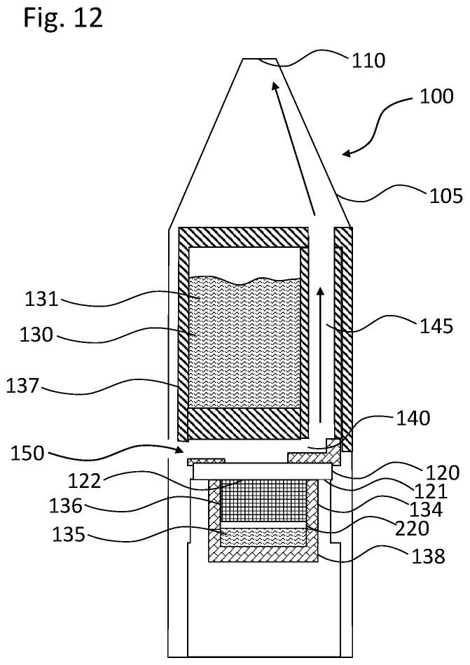

FIG. 12 is a schematic cross section of a cartridge with an alternative pressing element; and

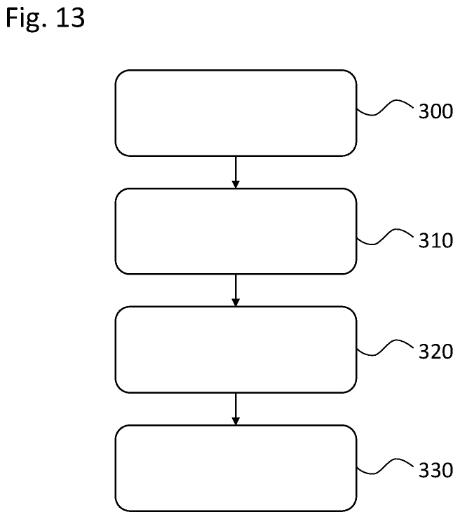

FIG. 13 is a flow diagram of a method of assembling an aerosol-generating system.

FIG. 1 is a schematic illustration of an aerosol-generating system in accordance with the disclosure. The system comprises two main components, a cartridge 100 and a reusable device or control body 200. A connection end 115 of the cartridge 100 is removably connected to a corresponding connection end 205 of the control body 200. The control body 200 contains a battery 210, which in this example is a rechargeable lithium ion battery, and control electronics 220. The aerosol-generating system is portable and has a size comparable to a conventional cigar or cigarette.

The cartridge 100 comprises a housing 105 containing a heater assembly 120 and a liquid storage compartment having a first portion 130 and a second portion 135. A liquid aerosol-forming substrate is held in the liquid storage compartment. Although not illustrated in FIG. 1, the first portion 130 of the liquid storage compartment is connected to the second portion 135 of the liquid storage compartment so that liquid in the first portion 130 can pass to the second portion 135. The heater assembly 120 receives liquid from the second portion 135 of the liquid storage compartment. In this embodiment, the heater assembly 120 comprises a generally planar, fluid permeable heating element.

An air flow passage 140, 145 extends through the cartridge 100 from an air inlet 150 past the heater assembly 120 and from the heater assembly 120 to a mouth end opening 110 in the cartridge housing 105.

The components of the cartridge 100 are arranged so that the first portion 130 of the liquid storage compartment is between the heater assembly 120 and the mouth end opening 110, and the second portion 135 of the liquid storage compartment is positioned on an opposite side of the heater assembly 120 to the mouth end opening 110. In other words, the heater assembly 120 lies between the two portions 130, 135 of the liquid storage compartment and receives liquid from the second portion 135, and the first portion 130 of liquid storage compartment is closer to the mouth end opening 110 than the second portion 135 of the liquid storage compartment. The air flow passage extends past the heater assembly 120 and between the first and second portion 130, 135 of the liquid storage compartment.

The system is configured so that a user can puff or suck on the mouth end opening 110 of the cartridge 100 to draw aerosol into their mouth. In operation, when a user puffs on the mouth end opening 110, air is drawn through the airflow passage 140, 145 from the air inlet 150, past the heater assembly 120, to the mouth end opening 110. The control electronics 220 controls the supply of electrical power from the battery 210 to the cartridge 100 when the system is activated. This in turn controls the amount and properties of the vapour produced by the heater assembly 120. The control electronics 220 may include an airflow sensor and the control electronics may 220 supply electrical power to the heater assembly 120 when user puffs on the cartridge 100 are detected by the airflow sensor. This type of control arrangement is well established in aerosol-generating systems such as inhalers and e-cigarettes. So when a user sucks on the mouth end opening 110 of the cartridge 100, the heater assembly 120 is activated and generates a vapour that is entrained in the air flow passing through the air flow passage 140. The vapour cools with in the airflow in airflow passage 145 to form an aerosol, which is then drawn into the user's mouth through the mouth end opening 110.

In operation, the mouth end opening 110 is typically the highest point of the device. The construction of the cartridge 100, and in particular the arrangement of the heater assembly 120 between first and second portions 130, 135 of the liquid storage compartment, is advantageous because it exploits gravity to ensure that the liquid substrate is delivered to the heater assembly 120 even as the liquid storage compartment is becoming empty, but prevents an oversupply of liquid to the heater assembly 120 which might lead to leakage of liquid into the air flow passage 140.

Although the embodiment described here are of a two piece system comprising a cartridge and a reusable device containing the power supply and control electronics, it is possible to implement the same arrangement for the liquid storage and airflow in a one piece system, in which the power supply and control electronics are provided in a unitary housing with the heater assembly, liquid storage and mouthpiece. Accordingly, any reference to a cartridge in the embodiments below can equally applied to an entire, one-piece system.

FIG. 2 is a first cross section of a cartridge in accordance with an embodiment of the invention. FIG. 3 is a second cross section, orthogonal to the cross section of FIG. 2.

The cartridge 100 of FIGS. 2 and 3 comprises an external housing 105 having a mouth end with a mouth end opening 110, and a connection end opposite the mouth end. Within the housing 105 is the liquid storage compartment holding a liquid aerosol-forming substrate 131. The liquid is contained in the liquid storage compartment by three components, an upper storage compartment housing 137, a heater mount 134 and an end cap 138. A heater assembly 120 is held in the heater mount 134. A wicking element 136 is provided in the second portion 135 of the liquid storage compartment, and abuts the heating element in a central region of the heater assembly 120. The wicking element is oriented to transport liquid to the heating element. The heating element122 comprises a mesh heating element, formed from a plurality of filaments. Details of this type of heating element construction can be found in WO2015/117702 for example. An airflow passage 140 extends between the first and second portions 130, 135 of the liquid storage compartment. A bottom wall of the airflow passage 140 comprises the heating element122 and the heater mount 134, side walls of the airflow passage 140 comprise portions of the heater mount 134, and a top wall of the airflow passage 140 comprises a portion of the upper storage compartment housing 137. The air flow passage 140 has a vertical portion 145 that extends through the first portion 130 of the liquid storage compartment, as shown in FIG. 2, towards the mouth end opening 110.

The heater assembly 120 is generally planar and has two faces. A first face of the heater assembly 120 faces the first portion 130 of the liquid storage compartment and the mouth end opening 110. A second face of the heater assembly 120 is in contact with the wicking element 136 and the liquid 131 in the liquid storage compartment, and faces a connection end 115 of the cartridge 100. The heater assembly 120 is closer to the connection end so that electrical connection of the heater assembly 120 to a power supply can be easily and robustly achieved, as will be described. The first portion 130 of the liquid storage compartment is larger than the second portion 135 of the liquid storage compartment and occupies a space between the heater assembly 120 and the mouth end opening 110 of the cartridge 100. Liquid in the first portion 130 of the liquid storage compartment can travel to the second portion 135 of the liquid storage compartment through liquid channels 133 on either side of the heater assembly 120. Two channels are provided in this example to provide a symmetric structure, although only one channel is necessary. The channels are enclosed liquid flow paths defined between the upper storage compartment housing 137 and the heater mount 134.

The wicking element 136 has a front face in contact with a contact surface of the heating element and a rear face opposite the front face. The front face of the wicking element 136 is pressed into contact with the contact surface of the heating element by the action of pressing elements 141, 142 against the rear face of the heating element. The pressing elements 141, 142 in the embodiment shown in FIGS. 2 and 3 are rods that are positioned between the wicking element and the end cap 138 of the housing. The pressing elements comprise a central pin 141 that contacts the wicking element in a central area of the rear face and a plurality of outer pins 142 that contact a periphery of the rear face. The central pin may be made longer that the outer pins in order to provide a greater compressive force in the central area of the wicking element. Spaces 144 between the pressing elements allow liquid aerosol-forming substrate to reach the wicking element. The central pin and the outer pins may themselves be hollow to allow liquid to pass through. The pressing elements improve the uniformity of contact between the wicking element and the heating element and so improve the uniformity of liquid delivery to the heating element.

The cartridge 100 shown in FIGS. 2 and 3 may be assembled by first moulding the heater mount 134 around the heater assembly 120. The heater assembly comprises a mesh heating element 122 as described, fixed to a pair of tin contact pads, which have a much lower electrical resistivity than the heating element 122. The contact pads 121 are fixed to opposite ends of the heating element 122. The heater mount 134 is then fixed to the upper storage portion housing using welding or adhesive. The wicking element 136 is inserted into the second portion 135 of the liquid storage compartment. The pressing elements and the end cap 138 are then fixed to the heater mount to seal the liquid storage compartment. The pressing elements 141, 142 may be integrally formed with the end cap 138. Alternatively, the heater mount 134, wicking element 136 and end cap 138 can be assembled first before being fixed to the upper storage portion housing.

FIG. 4 illustrates some possible cross-sectional shapes for the pressing elements 141, 142. As shown, the pressing elements can have a solid or hollow cross section. The examples shown in FIG. 4 are of a circular cross-section 150,151, a triangular cross-section 152, 153, a rectangular cross-section 154, 155, a pentagonal cross-section 156, 157 and a cross shaped cross-section 158, 159.

FIG. 5 shows another example of a pressing element. A single pressing element in a honeycomb structure 160 could be used, extending across some or all of the rear face of the wicking element.

FIG. 6 is an exploded view of a cartridge of the type shown in FIG. 2, but with a different housing structure. The cartridge comprises an upper storage housing 170 that forms a mouthpiece and a rear housing 172 that a joined by a seal joint 174. The heater assembly is held within a heater mount 176. The heater mount is moulded around the heater assembly to secure the heater assembly. The heater mount 176 is held within the rear housing 172. Opening are provided in the rear housing to allow electrical contact between the heater assembly and an external power supply. A wicking element 178 is provided in the heater mount 176, to contact the heater assembly as described in relation to the embodiment of FIGS. 2 and 3. A removable seal tab 177 is provided to cover the heating element prior to use. A flavour identification piece 179 is provided at the mouthpiece end of the upper storage housing to indicate the flavour of the liquid held within the cartridge.

FIG. 7 is a cross section of the wicking element of the cartridge of FIG. 6. The wicking element 178 has a front face 180 and a rear face 182. The front face 180 is domed. The rear face 182 is planar. The wicking element is oriented so that the front face contacts the heating element. As shown in FIG. 7, the rear face 182 has a central area 184 and a peripheral area 186.

FIG. 8 shows a cross section through a portion of the rear housing and heater mount of the cartridge of FIG. 7. FIG. 8 shows the wicking element 178 with its front face in contact with a heating element 192 held within the heater mount 176. The front face of the wicking element 178 is pressed into contact with the heating element 192 by a pressing element 190. The pressing element 190 rests on the rear housing 172. The pressing element 190 contacts the periphery of the rear face of the wicking element to urge it against the heating element. This provides a contact between the heating element and the wicking element to ensure continuous and consistent delivery of liquid to the heating element.

FIGS. 9a, 9b, and 9c show different views of the pressing element 190 of FIG. 8. FIG. 9a is a perspective view, FIG. 9b is a plan view and FIG. 9c is a cross-section view. The pressing element comprises an annular hub 194 from which four protrusions 196 extend. A central bore 198 is formed in the annular hub that liquid substrate can pass through. The protrusions 196 contact the wicking element and press it into contact with the heating element. The height of the protrusions can be chosen to provide the required pressing force. The pressing element of FIGS. 9a, 9b, and 9c is robust and able to provide a significant compressive force on the wicking element.

FIGS. 10a and 10b show an alternative design for the pressing element. The pressing element shown in FIGS. 10a and 10b is similar to the pressing element shown in FIG. 9a. The pressing element comprises an annular hub 204 from which four protrusions 206 extend. A central bore is formed in the annular hub that liquid substrate can pass through. The protrusions 206 contact the wicking element and press it into contact with the heating element. However, the front face 208 of the pressing element, formed by the protrusions, has a convex, domed shape matching the domed shape of the wicking element. The protrusions 206 also extend further inward that the protrusions of the embodiment of FIG. 9a, providing a greater pressing force in the central area of the rear face of the wicking element.

FIG. 11 shows a further alternative design for the pressing element. The pressing element shown in FIG. 11is similar to the pressing element shown in FIGS. 10a and 10b. The pressing element comprises an annular hub 214 from which four protrusions 216 extend. A central bore is formed in the annular hub that liquid substrate can pass through. The protrusions 216 contact the wicking element and press it into contact with the heating element. The front face 218 of the pressing element, formed by the protrusions, has a convex, domed shape matching the domed shape of the wicking element. In the embodiment of FIG. 11, the front face 218 has a smaller diameter than the front face 208 of the embodiment of FIGS. 10a and 10b. This removes the compressive force on the periphery of the wicking element and provides compressive force only in the central area.

FIG. 12 is a schematic cross section of a cartridge with an alternative pressing element. FIG. 12 shows a cross sectional view of a cartridge similar to FIG. 2. The same reference numerals have been used in FIG. 12 as used in FIG. 2 for identical elements.

The cartridge 100 of FIG. 12 comprises an external housing 105 having a mouth end with a mouth end opening 110, and a connection end opposite the mouth end. Within the housing 105 is the liquid storage compartment holding a liquid aerosol-forming substrate 131. The liquid is contained in the liquid storage compartment by three components, an upper storage compartment housing 137, a heater mount 134 and an end cap 138. A heater assembly 120 is held in the heater mount 134. A wicking element 136 is provided in the second portion 135 of the liquid storage compartment, and abuts the heating element in a central region of the heater assembly 120. The wicking element is oriented to transport liquid to the heating element. The heating element 122 comprises a mesh heating element. An airflow passage 140 extends between the first and second portions 130, 135 of the liquid storage compartment. A bottom wall of the airflow passage 140 comprises the heating element122 and the heater mount 134, side walls of the airflow passage 140 comprise portions of the heater mount 134, and a top wall of the airflow passage 140 comprises a portion of the upper storage compartment housing 137. The air flow passage 140 has a vertical portion 145 that extends through the first portion 130 of the liquid storage compartment.

The heater assembly 120 is generally planar and has two faces. A first face of the heater assembly 120 faces the first portion 130 of the liquid storage compartment and the mouth end opening 110. A second face of the heater assembly 120 is in contact with the wicking element 136 and the liquid 131 in the liquid storage compartment, and faces a connection end 115 of the cartridge 100. The heater assembly 120 is closer to the connection end so that electrical connection of the heater assembly 120 to a power supply can be easily and robustly achieved, as will be described. Liquid in the first portion 130 of the liquid storage compartment can travel to the second portion 135 of the liquid storage compartment through liquid channels 133 on either side of the heater assembly 120.

The wicking element 136 has a front face in contact with a contact surface of the heating element and a rear face opposite the front face. The front face of the wicking element 136 is pressed into contact with the contact surface of the heating element by the action of a mesh pressing element 220 against the rear face of the heating element. The mesh pressing element may be press fit or otherwise mechanically secured to the heater mount 134. For example the heater mount may include one or more interior ribs that the mesh pressing element 220 can be pushed past. The pressing element, when secured to the heater mount, provides a compressive force across the rear surface of the wicking element. The mesh pressing element 220 may have a honeycomb structure, as illustrated in FIG. 5 for example.

FIG. 13 is a flow diagram of a method of assembling an aerosol-generating system or cartridge as described above. In a first step 300, a housing for enclosing a reservoir of liquid aerosol-forming substrate, a heating element and a compressible wicking element are provided. The heating element may be provided in a heater mount as described above. The heater mount may hold the wicking element. In a second step 310, the wicking element is pressed against a contact surface of the heating element using a pressing element, such that the wicking element is positioned between the pressing element and the heating element. This may be done as the heater mount is secured to the housing, with the pressing element integral with the housing or sandwiched between the housing and the wicking element. In a third step 320, the housing is filled with liquid aerosol-forming substrate. The liquid aerosol-forming substrate is drawn into the wicking element and so into contact with the heating element. In a fourth step 330, the housing is sealed to prevent the escape of the liquid aerosol-forming substrate prior to use.

1.-15. (canceled)

16. A cartridge for an aerosol-generating system, the cartridge comprising:
a housing enclosing a reservoir of liquid aerosol-forming substrate;
a heating element having a contact surface;
a compressible wicking element positioned in contact with the contact surface of the heating element and in communication with the liquid aerosol-forming substrate in the reservoir; and
a pressing element, wherein the compressible wicking element is positioned between the pressing element and the heating element, and
wherein the pressing element presses against the compressible wicking element to urge the compressible wicking element into contact with the contact surface of the heating element.

17. The cartridge according to claim 16,
wherein the compressible wicking element has a front face in contact with the contact surface of the heating element and a rear face in contact with the pressing element, and
wherein the pressing element contacts the rear face in a central area spaced inwardly from a periphery of the rear face.

18. The cartridge according to claim 17, wherein the pressing element is provided so that the compressible wicking element is compressed to a greater extent in the central area than at the periphery of the rear face.

19. The cartridge according to claim 17, wherein the compressible wicking element has greater thickness in the central area than at the periphery.

20. The cartridge according to claim 17, wherein, in an uncompressed state, the compressible wicking element has a greater porosity in the central area than at the periphery.

21. The cartridge according to claim 16, wherein the pressing element is liquid-permeable.

22. The cartridge according to claim 16, wherein the pressing element comprises hollow pressing member that liquid aerosol-forming substrate from the reservoir can pass through to reach the wicking material.

23. The cartridge according to claim 16, wherein the heating element is fluid-permeable.

24. The cartridge according to claim 16, wherein the heating element is planar.

25. The cartridge according to claim 16, wherein the heating element comprises a mesh.

26. The cartridge according to claim 16, wherein the heating element comprises electrical contacts for connection with an external power supply.

27. The cartridge according to claim 16, wherein the heating element comprises a susceptor configured to be inductively heated to vapourise the liquid aerosol-forming substrate.

28. The cartridge according to claim 16, wherein the pressing element comprises a dome-shaped surface in contact with a rear face of the compressible wicking element.

29. The cartridge according to claim 16, wherein the liquid aerosol-forming substrate from the reservoir can pass the pressing element in a direction in which the pressing element presses against the compressible wicking element.

30. An aerosol generating system comprising the cartridge according to claim 16.
